(19) United States
(12) Patent Application Publication
(10) Pub. No.: US 2010/0301997 A1
(43) Pub. Date: Dec. 2, 2010

(54) METHODS FOR AUTHENTICATING THE IDENTITY OF INDIVIDUALS RESPONSIBLE FOR MAINTAINING ELECTRICALLY OPERATED FOLDING PARTITIONS

(75) Inventors: Stephen F. Cole, Great River, NY (US); Kathleen Cole, Great River, NY (US)

Correspondence Address: DILWORTH & BARRESE, LLP, 1000 WOODBURY ROAD, SUITE 405, WOODBURY, NY, 11797, US

(73) Assignee: GYM DOOR REPAIRS, INC., Huntington Station, NY (US)

(21) Appl. No.: 12/788,720

(22) Filed: May 27, 2010

Related U.S. Application Data
(60) Provisional application No. 61/217,079, filed on May 27, 2009.

(51) Int. Cl. G06F 7/04; E06B 3/00

(52) U.S. Cl. 340/5.53; 49/506

(57) ABSTRACT

A method for maintaining the folding operable wall comprising: (a) recording a template of a biological trait of an authorized individual into a biometric verification system; (b) saving the template in a database; (c) capturing a new record; (d) comparing the new record against the template; (e) confirming the identity of the authorized individual if the new record is substantially similar to the saved template; (f) preventing the electrical operation circuit from functioning if the biometric verification system fails to authenticate the identity of the authorized individual; and (g) restarting the electrical operation circuit after the identity of the authorized individual is verified.

### CROSS-REFERENCE TO RELATED APPLICATIONS

This application claims priority to U.S. Provisional Application No. 61/217,079 filed May 27, 2009, which is herein incorporated by reference in its entirety

### TECHNICAL FIELD

The present disclosure generally relates to electrically operated folding partitions, and more particularly to methods for verifying the identity of individuals responsible for maintaining and/or servicing electrically operated folding partitions.

### BACKGROUND

Portable folding partitions or walls having a plurality of vertically oriented panels have conventionally been used to provide temporary walls to, for example, divide off two or more areas of a given room. In particular, folding portable partitions provide a quick and efficient means to divide large open rooms, such as a school gymnasium or auditorium, into smaller areas. The vertically oriented panels are suspended from a horizontal rail system along which the panels are movable. In order to facilitate movement of the portable folding partitions, casters or wheels may be used, which allow the portable partition to be easily positioned to the desired location, and then rolled back into its storage area for later use.

Portable folding partitions have been adapted to include mechanisms which open and close the moving partitions automatically by an electrical system. Electrically operated folding partitions, like any other mechanical apparatus, need to be maintained in order to function safely and efficiently. Indeed, in order to ensure that electrically operated folding partitions function as intended, many states have enacted laws requiring schools to maintain electrically operated folding partitions in accordance with the manufacturer's instructions, including the manufacturer's recommended service interval.

Due to the large amount of force needed to move the weight of the folding partitions, electrically operated folding partitions can cause injury, or even death, to a person who accidentally becomes trapped between the partitions; therefore demonstrating the importance of properly maintaining electrically operated folding partitions. In order to prevent accidents caused by electrically operated folding partitions, some electrically operated folding partitions have been adapted to include a key which an operator, such as a person servicing/maintaining the electrically operated folding partition, is required to turn, while simultaneously holding a switch, to open or close the electrically operated folding partition. In theory, these types of electrically operated folding partitions provide an added layer of security over conventional electrically operated folding partitions, because some able individual would presumably be watching the partition the entire time it is opening or closing. Accordingly, the individual(s) could stop the folding partition from opening or closing if an object, such as a person, enters the path of the folding operable wall.

However, this type of electrically operated folding partition can easily be overridden, by, for example, wedging an object in the switch to hold it down, thus allowing the electrically operated folding partition to operate unsupervised. Moreover, the keys used in this type of electrically operated folding partition may be stolen, therefore allowing the electrically operated folding partitions to be accessed and operated by unauthorized, untrained users. Furthermore, a careless individual in charge of servicing the electrically operated folding partition may provide the key to an individual who is neither trained nor authorized, thus allowing the unauthorized, untrained individual to access and service the electrically operated folding partition.

Accordingly, in order to make electrically operated folding partitions more safe, many states have enacted laws requiring schools to install a safety device that will (a) stop the forward motion of an electrically operated folding partition whenever a person passes between the moving partition and the wall, and (b) stop the partition when a person is present in an area where the partition is being stacked. One such example of this type of electrically operated folding partition is described in U.S. Pat. No. 5,244,030 to Cole et al., the contents of which are incorporated herein by reference. In particular, the electrically operated folding partition described in U.S. Pat. No. 5,244,030 to Cole et al. includes a mechanism for shutting down the electrical operation circuit of the folding operable walls when a physical obstruction interrupts an infrared barrier curtain on opposite sides of an operating path of the folding operable walls.

However, even with electrically operated folding partitions containing automatic reversal sensors or automatic shut-off sensors there is danger that an undetected individual will become trapped between the folding partitions. Accordingly, many states have enacted laws requiring schools to equip electrically operated folding partitions with two key-operated, tamper-proof, constant pressure control stations that are wired in series, and are remotely located at opposite ends. These requirements are designed to ensure that electrically operated folding partitions require simultaneous activation of both control stations to operate the partition. In theory, requiring an operator to be present at each end of the electrically operated folding partition the entire time the electrically operated folding partitions is being operated ensures that someone will be supervising each end of the electrically operated folding partition.

However, there remains a danger that the person who assumes the duty to maintain the electrically operated folding partition is not competent to do so, therefore elevating the potential for an accident. Indeed, conventional electrically operated folding partitions do not provide any means to validate if an individual is authorized to maintain/service the electrically operated folding partition, other than perhaps a key, which as discussed above, can easily be compromised.

In general, an individual's identity may be validated by possession-based information, such as a fingerprint or identification card. Biometrics is the science and technology of measuring and analyzing biological data. Biometric verification is any means by which an individual can be uniquely identified by evaluating one or more distinguishing biological traits. Unique identifiers include fingerprints, facial geometry, hand geometry, earlobe geometry, retina and iris patterns, and voice patterns. In general, biometric verification systems record a person's unique biological traits, which are kept in a database during an enrollment phase. When identification verification is subsequently required, a new record is captured and compared with the records in the database stored in the test phase to estimate the distance between the new record and the stored templates using an algorithm. If the data in the new record matches that in the database record, the person's identity is confirmed.

Fingerprint authentication or verification is a physiological biometric which involves verifying a match between two fingerprints, and requires the comparison of several features of the fingerprint pattern. These include patterns which are aggregate characteristics of ridges and minutia points; characteristics found within the fingerprint patterns. The three basic patterns of fingerprint ridges are the arch, loop, and whorl. Minutiae and patterns are very important in the analysis of fingerprints since no two fingerprints have been shown to be identical, even in the case of identical twins. Moreover, because one's fingerprints typically do not change over the lifetime of an individual, fingerprints are a reliable way to identify an individual.

Fingerprint recognition systems use sensors to capture a digital image of the fingerprint pattern. The captured image is typically referred to as a “live scan.” The live scan is digitally processed to create a biometric template, which is stored in a database. When identification verification is subsequently required, a new record is captured and compared with the records in the database. If the data in the new record matches that in the database record, the person's identity is confirmed. A variety of different sensors can be used to capture digital images of fingerprints. Indeed, fingerprint sensors may include, for example: (a) optical sensors which capture a digital image of a fingerprint using visible light; (b) ultrasonic sensors which use the principles of medical ultrasonography to create visual images of the fingerprint; and (c) capacitance sensors which use the principles associated with capacitance to form fingerprint images.

Matching algorithms are used to compare previously stored templates of fingerprints (live scans) against candidate fingerprints for authentication purposes. Pattern-based algorithms compare the basic fingerprint patterns between a previously stored live scan and a candidate fingerprint. The candidate fingerprint image is graphically compared with the template to determine the degree to which they match. If the data in the candidate fingerprint matches the template in the database record, the person's identity is confirmed. It is understood that an exact match is not required to confirm a person's identity. Indeed, substantial matches between the candidate fingerprint and the template (e.g. a 90% or greater match) may be sufficient to confirm a person's identity.

Facial recognition systems are physiological biometric systems which verify a person from a digital image or a video frame from a video source. Facial recognition systems use facial recognition algorithms to identify specific features from a person's face. For example, an algorithm may analyze the relative position, size, and/or shape of the person's eyes, nose, cheekbones, and jaw (facial geometry). 3-D sensors may be used to capture information about the shape of the face. Skin texture may be analyzed to compare unique lines, patterns, and spots apparent in one's skin. This information is then converted into a digital format to provide a mathematical representation of the individual's face (candidate), which is used to search for other images with matching characteristics (e.g. skin texture, shapes and features). If the data in the candidate matches a record in the database record, the person's identity is confirmed. It is understood that an exact match is not required to confirm a person's identity. Indeed, substantial matches between the candidate and a record in the database (e.g. a 90% or greater match) may be sufficient to confirm a person's identity.

Iris recognition is a method of physiological biometric authentication that uses pattern recognition techniques based on high-resolution images of the iris, which is the colored area that surrounds the pupil. Iris recognition systems use cameras to create images of the intricate concentric circular outer boundaries of the iris and the pupil in a photograph of the eye. When these images are converted into digital templates, they provide mathematical representations of the iris, which are compared against iris images stored in a database. In that iris patterns are unique, comparing a new record to iris structures in a database provides for the unambiguous positive identification of an individual.

Retina recognition is a method of physiological biometric authentication which captures and analyzes the patterns of blood vessels on the thin nerve on the back of the eyeball that processes light entering through the pupil. Retinal patterns are highly distinctive traits. Indeed, every eye has its own unique pattern of blood vessels, even in the case of identical twins. Moreover, a person's pattern of blood vessels typically remains fixed over one's lifetime, therefore making retina recognition a reliable way to identify an individual. Retinal recognition systems convert images of an individual's retinal patterns into digital templates, to provide mathematical representations of the pattern of blood vessels in the retina, which can be compared to retinal patterns stored in a database to yield unambiguous positive identification of an individual.

Hand geometry is a physiological biometric that identifies users by the shape of their hands. Hand geometry recognition systems measure the physical characteristics of a person's hand, including length, width, thickness, and surface area, for example, and compare those measurements to measurements stored in a database.

Ear lobe geometry is a physiological biometric that identifies users by the shape of their ear lobes. Ear lobe geometry recognition systems measure the physical characteristics of a person's ear lobes, and compare those measurements to measurements stored in a database.

Speaker recognition is a type of behavioral biometric which validates a person's identity using characteristics from their voice, and is based on the premise that the acoustic features of speech differ between individuals. Indeed, one's acoustic patterns are a result of both anatomy and learned behaviors. Speaker recognition systems have an enrollment phase and a test phase. In the enrollment phase, the speaker's voice is recorded and a number of features are extracted to form a “voice print.” In the test phase, one's speech is compared against a voice print to determine if the person's voice matches the voice print. If the speech recorded by the individual matches the voice print in the database record, the person's identity is confirmed.

Each of the biometric verification systems describe above record a person's unique biological traits, which are kept in a database during an enrollment phase, and then capture a new record when identification verification is required; the verification systems then compare the new record with the records in the database to estimate the distance between the new record and the stored templates, using an algorithm. If the data in the new record matches that in the database record, the person's identity is confirmed.

Accordingly, each of the biometric verification systems described above function to verify the identity of an individual, based on the individual's unique biological traits. It is envisioned that each of the biometric verification systems described above may be coupled to an electrically operated folding partition system to verify the identity of the person responsible for maintaining the same, before the electrically operated folding partition becomes operable. It is also envisioned that each of the biometric verification systems described above may be coupled to an electrically operated folding partition system to verify the identity of the person responsible for maintaining the same while the electrically operated, folding partition is in operation, such that the electrically operated folding partition will cease to operate if the biometric verification system is unable to verify the person's biological information. In that the person responsible for maintaining the electrically operated folding partition is required to be physically present (to provide biological data), the electrically operated folding partition will not operate, or will cease to operate, if the person is not present. As discussed above, biometric authentication requires certain possession-based information, such as a fingerprint or retinal scan in order to verify the identity of an individual. Hence, an authorized individual is required to be physically present to provide the required biometric information.

However, artificial reproductions of an individual's unique biological traits may be created which can circumvent an authentication system which verifies the identity of an individual based on biometric characteristics. Indeed, artificial fingers and/or fingerprints may be fabricated using liquid silicone rubber, for example. Methods for fabricating artificial fingers and/or fingerprints are described in Cheng, et al., Artificial Fingerprint Recognition By Using Optical Coherence Tomography With Autocorrelation Analysis, Applied Optics, Vol. 45, No. 36 (2006); Matsumoto, et al., Impact of Artificial “Gummy” Fingers on Fingerprint Systems, SPIE, vol. 4677 (2002); van der Putte, et al., Biometric Fingerprint Recognition Don't Get Your Fingers Burned, SMART CARD RESEARCH AND ADVANCED APPLICATIONS, IFIP TC8/WG8.8 Fourth Working Conference on Smart Card Research and Advanced Applications, pp. 289-303 (2001); and U. Uludag et al., Attacks on Biometric Systems: A Case Study in Fingerprints,” SPIE, vol. 5306, pp. 622-633 (2004); the contents of which are incorporated herein by reference.

It is envisioned that artificial fingers and/or fingerprints may be created from the finger/fingerprint of an authorized individual whose fingerprint is stored in a database of an authentication system during an enrollment phase, so that the authorized individual may provide the artificial finger/fingerprint to an individual whose fingerprint is not recorded in the database (did not participate in the enrollment phase), which allows that individual to service the electrically operated folding partition. Moreover, artificial fingers/fingerprints may be created as substitutes in order to solve the problem when a legitimate user (who participated in the enrollment phase) cannot gain access, due to, for example, an injury to his or her fingertip.

Photographic images of an individual's face, earlobe, hand, iris, and retina artificially reproduce certain characteristics of an individual's face, earlobe, hand, iris, and retina. These artificial reproductions (images) may be created to circumvent facial recognition systems, earlobe geometry recognition systems, hand geometry recognition systems, iris recognition systems, and retina recognition systems, respectively. Indeed, it is envisioned that photographic images can circumvent the particular authentication system to provide a trained, authorized individual responsible for maintaining the electrically operated folding partition (who participated in the enrollment phase) the ability to have other trained individuals, whose biometric characteristics are not recorded in a database (did not participate in the enrollment phase), operate, and hence service, the electrically operated folding partition. Moreover, photographic images may be created as substitutes in order to solve the problem when a legitimate user cannot gain access, due to, for example, an injury to his or her face, ear, hand, or eye.

Artificial reproductions of an individual's voice may be used to circumvent voice or speaker recognition systems. Indeed, an authorized individual, whose voice print is recorded in a database (who participated in the enrollment phase) may record his or her voice to create an artificial reproduction thereof. He or she may provide the recording to an individual whose voice print is not recorded in the database (did not participate in the enrollment phase), in order to allow that individual to access and operate the electrically operated folding partition. Moreover, recordings of an authorized individual's voice, whose voice print is recorded in a database, may be used as substitutes when a legitimate user cannot gain access, due to, for example, temporary or permanent voice loss.

Therefore, it would be desirable to provide a method for verifying the identity of the individual(s) responsible for servicing/maintaining the electrically operated folding partition. Desirably, the electrically operated folding partition will be inoperable unless and until the identity of the individual(s) responsible for servicing/maintaining the electrically operated folding partition can be verified. It would also be desirable if the electrically operated folding partition will cease to operate if the verification mechanism is unable to verify the identity of the individual(s) responsible for servicing/maintaining the electrically operated folding partition the entire time the folding partition is in operation. It would be further desirable if the identity of the individual(s) responsible for servicing/maintaining the electrically operated folding partition were verified using a biometric authentication mechanism to compare biometric characteristics. It would also be most desirable if the identity of the individual(s) responsible for servicing/maintaining the electrically operated folding partition can be verified using an artificial reproduction of the biological trait assessed by the biometric verification system to circumvent the authentication mechanism, to allow the individual(s) responsible for servicing/maintaining the electrically operated folding partition, as well as other individuals, to service/maintain the electrically operated folding partition system.

### SUMMARY OF THE INVENTION

Accordingly, the present disclosure provides a method for verifying the identity of the individual(s) responsible for servicing/maintaining the electrically operated folding partition. Desirably, the electrically operated folding partition is inoperable unless and until the identity of the individual(s) responsible for servicing/maintaining the electrically operated folding partition can be verified. It would also be desirable if the electrically operated folding partition will cease to operate if the verification mechanism is unable to verify the identity of the individual(s) responsible for servicing/maintaining the electrically operated folding partition the entire time the folding partition is in operation. It would be further desirable if the identity of the individual(s) responsible for servicing/maintaining the electrically operated folding partition were verified using a biometric authentication mechanism to compare biometric characteristics. It would also be most desirable if the identity of the individual(s) responsible for servicing/maintaining the electrically operated folding partition can be verified using an artificial reproduction of the biological trait assessed by the biometric verification system to circumvent the authentication mechanism, to allow the individual(s) responsible for servicing/maintaining the electrically operated folding partition, as well as other individuals, to service/maintain the electrically operated folding partition system.

In one embodiment, the method of the present invention involves an electrically operated folding operable wall controlled by an electrical operation circuit of the type having at least one control station, an extend control switch, a stack control switch, control relays and a motor.

In the method according the present disclosure, a template of at least one biological trait of an individual trained and authorized to maintain the folding operable wall is captured by a biometric verification system coupled to the at least one control station in an enrollment phase. The template is saved in a database within the biometric verification system.

When an individual trained and authorized to maintain the folding operable wall desires to gain access to the same, he or she must create or “capture” a new record of the same biological trait previously recorded by the individual trained and authorized to maintain the folding operable wall in the enrollment phase. The new record is compared against the template in a test phase to determine if the new record and the template are substantially similar, using an algorithm. The identity of the individual trained and authorized to maintain the folding operable wall is confirmed if the new record from the test phase is substantially similar to the template saved in the enrollment phase.

A preventing means prevents the electrical operation circuit of the folding operable wall from functioning if the biometric verification system fails to authenticate the identity of the individual trained and authorized to maintain the folding operable wall during the test phase. In particular, the preventing means includes at least one control unit electrically connected between each control station of the electrical operation circuit and each biometric verification system, which will prevent the control unit from functioning if the identity of the individual trained and authorized to maintain the folding operable wall is not verified.

A restarting means restarts the electrical operation circuit of the folding operable wall after the identity of the individual trained and authorized to maintain the folding operable wall is verified, wherein the restarting means includes a reset control key switch in the control unit, which when turned on will reactivate the electrical operation circuit and the biometric verification system.

In one embodiment, an individual trained and authorized to maintain the folding operable wall which desires to gain access to the same, may use an artificial reproduction of the biological trait previously recorded in an enrollment phase, for example, an artificial finger. A new record is obtained from the artificial reproduction of the biological trait previously recorded. In a test phase, the template is compared against the artificial reproduction of the biological trait previously recorded to determine if the artificial reproduction of the biological trait previously recorded and the template are substantially similar, using an algorithm. If the artificial reproduction of the biological trait previously recorded and the template are substantially similar, the identity of the individual whose biological trait was recorded during the enrollment phase is verified. Once the identity of the individual whose biological trait was recorded during the enrollment phase is verified, any individual having the artificial reproduction of the biological trait previously recorded will be able to access and operate the folding operable wall.

In particular, it is envisioned that artificial reproductions of biological traits may be produced, such as an artificial finger with fingerprints, for example, which a biometric verification system would not be able to distinguish from the real fingerprint. Indeed, an authorized individual whose fingerprint is stored in a database during an enrollment phase, may create artificial reproductions of his or her finger and/or fingerprints so that he or she may provide the artificial finger and/or fingerprints to an individual whose fingerprint is not recorded in the database (did not participate in the enrollment phase), which he or she may use to verify the identity of the authorized individual whose fingerprint is stored in a database during an enrollment phase. Once the identity of the authorized individual is verified, the individual whose fingerprint is not recorded in the database may access operate the electrically operated folding partition, in order to service the same. Moreover, artificial reproductions of biological traits from individuals trained an authorized to maintain and operate the electrically operated folding partition may be created as substitutes in order to solve the problem when a legitimate user cannot gain access, due to, for example, an injury to his or her fingertip.

It is envisioned that the methods of the present invention may be adapted for use with any biometric verification system. Preferably, biometric verification systems for use with the present invention are selected from the group consisting of: fingerprint recognition systems, facial recognition systems, earlobe geometry recognition systems, hand geometry recognition systems, iris recognition systems, retina recognition systems, voice recognition systems, and combinations thereof.

### BRIEF DESCRIPTION OF THE DRAWINGS

The features of the present disclosure will become more readily apparent from the specific description accompanied by the following drawings, in which:

FIG. 1 is a perspective view of the control station of one embodiment of the electrically operated folding partition system in accordance with the principles of the present disclosure;

FIG. 2 is a perspective view of the control station of one particular embodiment of the electrically operated folding partition system in accordance with the principles of the present disclosure;

FIG. 3 is a perspective view of the control station of another embodiment of the electrically operated folding partition system in accordance with the principles of the present disclosure; and

FIG. 4 is a perspective view of the control station of yet another embodiment of the electrically operated folding partition system in accordance with the principles of the present disclosure.

Like reference numerals indicate similar parts throughout the figures.

### DETAILED DESCRIPTION OF THE INVENTION

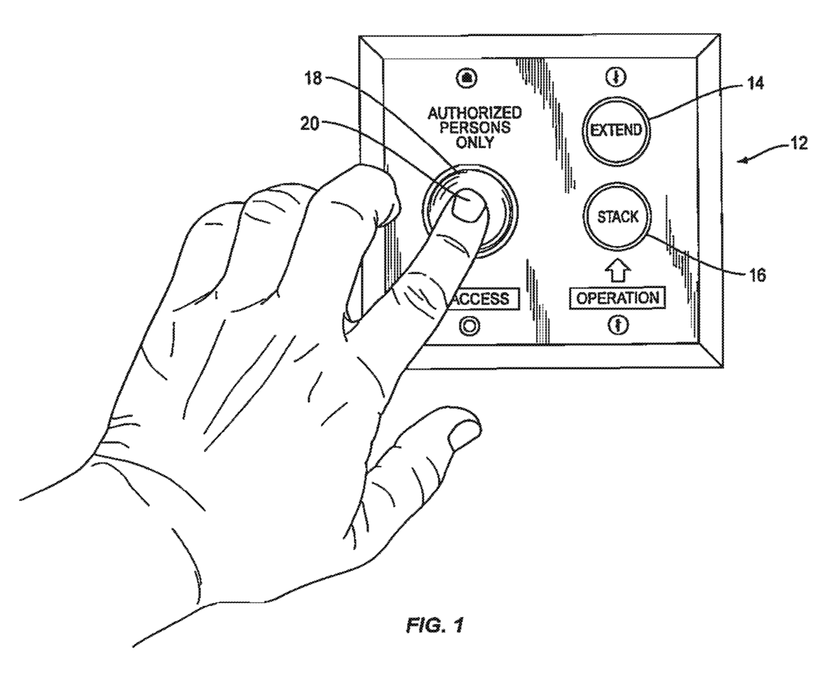

The following discussion includes a description of the methods of the subject invention, and related components. Alternate embodiments are also disclosed. Reference will now be made in detail to the exemplary embodiments of the present disclosure, which are illustrated in the accompanying figures. Turning now to FIGS. 1-4, the components of a method for authenticating the identity of individuals responsible for maintaining an electrically operated folding wall system, in accordance with the principles of the present disclosure, are illustrated.

In one embodiment, the method of the present invention involves an electrically operated folding operable wall controlled by an electrical operation circuit of the type having at least one control station 12, an extend control switch 14, a stack control switch 16, control relays and a motor. In another embodiment, the method of the present invention involves an electrically operated folding operable wall controlled by an electrical operation circuit where extend control switch 14 and stack control switch 16 are replaced by key switch 22 having a first position 22a and a second position 22b, which is used to stack and extend the electrically operated folding operable wall, respectively.

In a preferred embodiment, at least one control station 12 is disposed at each end of the electrically operated folding operable wall. In that the presence of at least one individual is required for each control station 12 in order to operate the electrically operated folding operable wall, by including at least one control station 12 on each side of the folding operable wall, the presence of at least two individuals is required the entire time the electrically operated folding wall is being operated. In another embodiment, the system of the present invention includes at least one control station 12 on one end of the electrically operated folding operable wall.

In the method according the present disclosure, a template of at least one biological trait of an individual trained and authorized to maintain the folding operable wall is first captured into a biometric verification system 18 coupled to control station 12, in an enrollment phase. Biological traits include, for example, fingerprints, facial geometry, hand geometry, earlobe geometry, retina and iris patterns, and voice waves.

Biometric verification systems suitable for use with the present invention include, for example, biometric verification systems selected from the group consisting of: fingerprint recognition systems, facial recognition systems, earlobe geometry recognition systems, hand geometry recognition systems, iris recognition systems, retina recognition systems, voice recognition systems, and combinations thereof.

In particular, the individual trained and authorized to maintain the folding operable wall will provide the required biological trait to biometric verification system 18 by, for example, placing his or her finger 20 on a fingerprint scanner in an enrollment phase, as shown in FIG. 1. The biometric verification system will create a template of the fingerprint from the scan of finger 20 obtained by the fingerprint scanner of biometric verification system 18.

The template is saved in a database or other memory device within biometric verification system 18. The template is later compared to a new record to verify the identity of the individual in a test phase, should the individual wish to access or operate the electrically operated folding operable wail. The methods of the present invention may include any biometric verification system which records a person's unique biological traits, and stores the same in a database during an enrollment phase; and then captures a new record when identification verification is subsequently required, to compare with the records in the database stored in the test phase to estimate the distance between the new record and the stored templates using an algorithm. In a preferred embodiment of the present invention, biometric verification system 18 includes a database or other memory device, which is a solid state memory.

When an individual trained and authorized to maintain the folding operable wall desires to gain access to the same, he or she must create or “capture” a new record of the same biological trait previously recorded in the enrollment phase, for example, a fingerprint. Indeed, the individual trained and authorized to maintain the folding operable wall may provide the required biological trait to biometric verification system 18 by, for example, placing his or her finger 20 on the fingerprint scanner included in biometric verification system 18, as shown in FIG. 1. The new record is compared against the template to determine if the new record and the template are substantially similar, using an algorithm. The identity of the individual trained and authorized to maintain the folding operable wall is confirmed if the new record from the test phase is substantially similar to the saved template from the enrollment phase.

In another embodiment of the present invention, an individual trained and authorized to maintain the folding operable wall which desires to gain access to the same, may use an artificial reproduction of the biological trait previously recorded in the enrollment phase. The template is compared against the artificial reproduction of the biological trait previously recorded to determine if the artificial reproduction of the biological trait previously recorded and the template are substantially similar, using an algorithm. If the artificial reproduction of the biological trait previously recorded and the template are substantially similar, the identity of the individual whose biological trait was recorded in the enrollment phase is confirmed, thus allowing any individual possessing the artificial reproduction of the biological trait previously recorded to operate the electrically operated folding operable wall.

For example, artificial reproductions of fingers and/or fingerprints may be created from finger 20 of an authorized individual whose fingerprint was previously stored in a database during an enrollment phase using methods known in the art. The authorized individual may provide the artificial finger/fingerprint to an individual whose fingerprint is not recorded in the database (did not participate in the enrollment phase). The individual whose fingerprint is not recorded in the database will provide the required biological trait (a fingerprint) to biometric verification system 18 in a test phase by, for example, placing the artificial finger/fingerprint on a fingerprint scanner included in biometric verification system 18. The new record of the artificial finger/fingerprint is compared against the template to determine if the new record and the template are substantially similar, using an algorithm. The identity of the individual trained and authorized to maintain the folding operable wall is confirmed if the new record (from the test phase) is substantially similar to the saved template (from the enrollment phase). Once the identity of the individual trained and authorized to maintain the folding operable wall is confirmed using the artificial finger/fingerprint, the individual whose fingerprint is not recorded in the database (did not participate in the enrollment phase) may nevertheless access and operate the electrically operated folding partition.

Furthermore, photographic images of an individual's face, earlobe, hand, iris, and retina may be used to artificially reproduce certain characteristics of an individual's face, earlobe, hand, iris, and retina, respectively. These artificial reproductions (images) may be created to circumvent biometric verification systems 18, such as, for example, facial recognition systems, earlobe geometry recognition systems, hand geometry recognition systems, iris recognition systems, and retina recognition systems. Indeed, photographic images can circumvent facial recognition systems, earlobe geometry recognition systems, hand geometry recognition systems, iris recognition systems, and retina recognition systems to provide a trained, authorized individual responsible for maintaining the electrically operated folding partition the ability to have other trained individuals, whose biometric characteristics are not recorded in a database (did not participate in the enrollment phase), operate, and hence service, the electrically operated folding partition.

The individual trained an authorized to operate electrically operated folding operable walls, who has entered his or her biological data, such as a his or her facial geometry, earlobe geometry, hand geometry, or iris and retina patterns, for example, into the biometric verification system during the enrollment phase, may provide photographic images of his or her face, for example, to an individual whose biological data is not recorded in the database (did not participate in the enrollment phase). The individual whose biological data is not recorded in the database will provide the required biological trait (a photographic image of an individual's retina, for example) to biometric verification system 18 by, for example, placing the photograph in front of a camera included in biometric verification system 18. The new record of the photographic image is compared against the template to determine if the new record and the template are substantially similar, using an algorithm. The identity of the individual trained and authorized to maintain the folding operable wall is confirmed during the test phase if the new record is substantially similar to the saved template. Once the identity of the individual trained and authorized to maintain the folding operable wall is confirmed, the individual whose biological data is not recorded in the database (did not participate in the enrollment phase) may nevertheless access and operate the electrically operated folding partition. Indeed, any individual possessing the artificial reproduction of the biological trait previously recorded may operate the electrically operated folding operable wall.

Artificial reproductions of an individual's voice may be used to circumvent voice or speaker recognition systems. Indeed, an authorized individual, whose voice print is recorded in a database of a voice recognition system during the enrollment phase, may record his or her voice to create an artificial reproduction thereof. He or she may provide the voice recording to an individual whose voice print is not recorded in the database (did not participate in the enrollment phase), in order to allow that individual to access and operate the electrically operated folding partition. The individual will be able to access and operate the folding operable wall if the voice recording is substantially similar to the saved template.

A preventing means prevents the electrical operation circuit of the folding operable wall from functioning if biometric verification system 18 fails to authenticate the identity of an individual which is trained and authorized to operate the folding operable wall, which has had his or her biological trait(s) recorded and saved by biometric verification system 18 in an enrollment phase, from the new record. In particular, the preventing means includes at least one control unit electrically connected between each control station 12 of the electrical operation circuit and each biometric verification system 18, which will prevent control unit from functioning if the identity of an authorized individual cannot be verified.

Moreover, because the preventing means includes at least one control unit electrically connected between each control station 12 of the electrical operation circuit and each biometric verification system 18, if biometric verification system 18 fails to authenticate the identity of the individual responsible for maintaining the electrically operated folding operable wall at any time in which the electrically operated folding operable wail is in operation, the electrically operated folding operable wall will cease to operate (is turned off from an on position).

A restarting means restarts the electrical operation circuit of the folding operable wall after the identity of the individual trained and authorized to maintain the folding operable wall is verified, wherein the restarting means includes a reset control key switch in at least one control unit, which when turned on will reactivate the electrical operation circuit and biometric verification system 18.

To normally close an electrically operated folding operable wall of an electrically operated folding operable wall system that includes an extend control switch 14 and a stack control switch 16, rather than a key switch 22, in accordance with the methods of the present invention, the individual responsible for maintaining the electrically operated folding operable wall must create a new record using biometric verification system 18 in a test phase. As shown in FIG. 1, the individual responsible for maintaining the electrically operated folding operable wall is required to place his or her finger 20 (or an artificial reproduction thereof) on a fingerprint scanner included in biometric verification system 18 in the test phase, which creates a new record of the individual's fingerprint (or an image of the artificial reproduction of a fingerprint from an authorized individual whose fingerprint was recorded in the enrollment phase) and compares the same the with fingerprint images in a database included in biometric verification system 18 obtained during an enrollment phase (templates). If the image of the fingerprint in the new record matches a template fingerprint image in the database, the identity of the individual from the enrollment phase is confirmed. Once the individual's identity is confirmed, the operator presses extend control switch 14. Pressing extend control switch 14 will electrically connects extend control switch 14 to control station 12, which will activate the proper control relays and motor. The electrically operated folding operable wall will then close along the operating path and extend to the distal side wall.

To normally open an electrically operated folding operable wall of an electrically operated folding operable wall system that includes an extend control switch 14 and a stack control switch 16, rather than a key switch 22, in accordance with the methods of the present invention, the individual responsible for maintaining the electrically operated folding operable wall must create a new record using biometric verification system 18. As shown in FIG. 1, the individual responsible for maintaining the electrically operated folding operable wall is required to place his or her finger 20 (or an artificial reproduction thereof) on a fingerprint scanner included in biometric verification system 18 to create a new record in a test phase, which captures an image of the individual's fingerprint (or an artificial reproduction thereof) and compares the image of the individual's fingerprint with the with fingerprint images in a database included in biometric verification system 18 obtained during an enrollment phase. If the image of the fingerprint matches in the new record matches a template fingerprint image in the database, the identity of the individual from the enrollment phase is confirmed. Once the individual's identity is confirmed, the individual responsible for maintaining the electrically operated folding operable wail presses stack control switch 16. After stack control switch 16 is pressed, stack control switch 16 will electrically connect through control station 12, which will activate the proper control relays and motor. The electrically operated folding operable wall will then open along the operating path and stack up to the stacked side wall.

If biometric verification system 18 is unable to verify the identity of the individual responsible for maintaining the electrically operated folding operable wall at any time in which the electrically operated folding operable wall is in operation, the preventing means will cause the electrically operated folding operable wall to stop. In particular, if biometric verification system 18 is unable to verify the identity of the individual responsible for maintaining the electrically operated folding operable wall, the preventing means will turn off control station 12, which in turn stops the motor. In order to continue opening or closing the electrically operated folding operable wall, the individual responsible for maintaining the electrically operated folding operable wall is required to follow the appropriate steps, as set forth above.

To normally close an electrically operated folding operable wall of an electrically operated folding operable wall system that includes a key switch, rather than an extend control switch 14 and a stack control switch 16, as shown in FIG. 4, in accordance with the methods of the present invention, the individual responsible for maintaining the electrically operated folding operable wall must create a new record using biometric verification system 18. For example, the individual responsible for maintaining the electrically operated folding operable wall may be required to place his or her finger 20 (or an artificial reproduction thereof) on a fingerprint scanner included in biometric verification system 18 in a test phase, as shown in FIG. 1, which captures an image of the individual's fingerprint and compares the image of the individual's fingerprint with the with fingerprint images in a database included in biometric verification system 18 obtained during an enrollment phase. If the image of the fingerprint in the new record matches a template fingerprint image in the database, the identity of the individual from the enrollment phase is confirmed. Once the individual's identity is confirmed, the operator turns key switch 22 to a first position 22a. After key switch 22 is turned to a first position 22a, key switch 22 will electrically connect through control station 12, which will activate the proper control relays and motor. The electrically operated folding operable wall will then close along the operating path and extend to the distal side wall.

In one particular embodiment of the present invention, in order to continue opening or closing the electrically operated folding operable wall after the preventing means has caused the electrically operated folding operable wall to stop, the individual responsible for maintaining the electrically operated folding operable wall is required to activate a reset control switch, before following the appropriate steps set forth above for opening and closing.

To normally open an electrically operated folding operable wall of an electrically operated folding operable wall system that includes a key switch, rather than an extend control switch 14 and a stack control switch 16, as shown in FIG. 4, the individual responsible for maintaining the electrically operated folding operable wall must create a new record using biometric verification system 18. For example, the individual responsible for maintaining the electrically operated folding operable wall may be required to place his or her finger 20 (or an artificial reproduction thereof) on a fingerprint scanner included in biometric verification system 18 in a test phase, as shown in FIG. 1, which captures an image of the individual's fingerprint and compares the image of the individual's fingerprint with the with fingerprint images in a database included in biometric verification system 18 obtained during an enrollment phase. If the image of the fingerprint in the new record matches a template fingerprint image in the database, the identity of the individual from the enrollment phase is confirmed. Once the individual's identity is confirmed, the operator turns key switch 22 to a second position 22b. After key switch 22 is turned to a second position 22b, key switch 22 will electrically connect through control station 12, which will activate the proper control relays and motor. The electrically operated folding operable wall will then open along the operating path and stack up to the stacked side wall. Switch 23 is a tamper resistant push button switch for actuation by the finger of a human operator for operation and control as described above in connection with extend control switch 14 and stack control switch 16.

If biometric verification system 18 is unable to verify the identity of the individual responsible for maintaining the electrically operated folding operable wall at any time in which the electrically operated folding operable wall is in operation, the preventing means will cause the electrically operated folding operable wall to stop. In particular, if biometric verification system 18 is unable to verify the identity of the individual responsible for maintaining the electrically operated folding operable wall, the preventing means will turn off control station 12, which in turn stops the motor. In order to continue opening or closing the electrically operated folding operable wall, the individual responsible for maintaining the electrically operated folding operable wall is required to follow the appropriate steps, as set forth above.

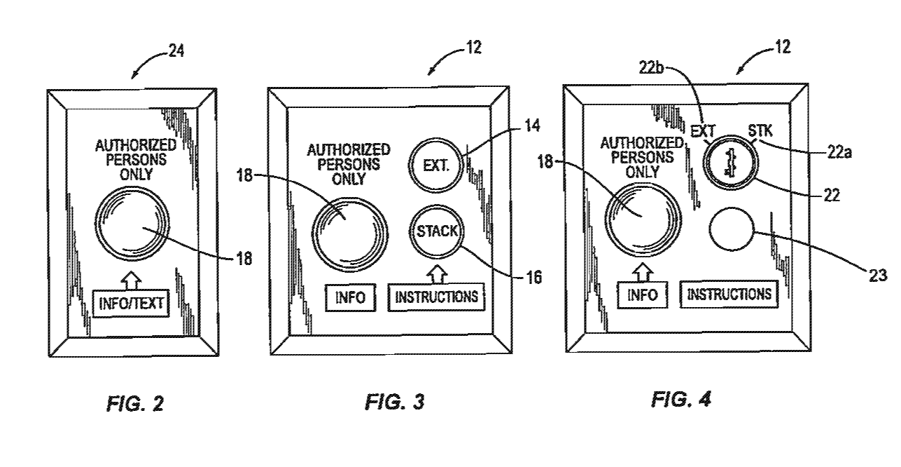

The methods of the present invention may be used in conjunction with existing electrically operated folding operable wall systems which include, for example, a key switch 22, an extend control switch 14, a stack control switch 16, a control station 12, control relays and a motor, yet lack a biometric verification system 18. Indeed, as shown in FIG. 2, an interface 24 having an biometric verification system 18 may be coupled to control station 12 of an existing electrically operated folding operable wall system to facilitate retrofitting to older equipment. Interface 24 permits operation of the extend control switch 14 and the stack control switch 16 when authentication of the operator is confirmed, and prevents operation of the extend control switch 14 and the stack control switch 16 when authentication of the operator is not confirmed. To normally close an electrically operated folding operable wall having such a system, the individual responsible for maintaining the electrically operated folding operable wall must create a new record using biometric verification system 18. For example, the individual responsible for maintaining the electrically operated folding operable wall may be required to place his or her finger 20 (or an artificial reproduction thereof) on a fingerprint scanner included in biometric verification system 18 in a test phase, as shown in FIG. 1, which captures an image of the individual's fingerprint and compares the image of the individual's fingerprint with the with fingerprint images in a database included in biometric verification system 18 obtained during an enrollment phase. If the image of the fingerprint in the new record matches a template fingerprint image in the database, the identity of the individual from the enrollment phase is confirmed. Once the individual's identity is confirmed, the individual responsible for maintaining the electrically operated folding operable wall either turns key switch 22 to a first position 22a, or presses an extend control switch 14. Turning key switch 22 to a first position 22a or pressing extend control switch 14 will electrically connect key switch 22 or extend control switch 14 through control station 12, which will activate the proper control relays and motor. The electrically operated folding operable wall will then close along the operating path and extend to the distal side wall.

To normally open an electrically operated folding operable wall having such a system, the individual responsible for maintaining the electrically operated folding operable wall must create a new record using biometric verification system 18. For example, the individual responsible for maintaining the electrically operated folding operable wall may be required to place his or her finger 20 (or an artificial reproduction thereof) on a fingerprint scanner included in biometric verification system 18 in a test phase, as shown in FIG. 1, which captures an image of the individual's fingerprint and compares the image of the individual's fingerprint with the with fingerprint images in a database included in biometric verification system 18 obtained during an enrollment phase. If the image of the fingerprint in the new record matches a template fingerprint image in the database, the identity of the individual from the enrollment phase is confirmed. Once the individual's identity is confirmed, the operator either turns key switch 22 to a second position 22b, or presses stack control switch 16. Turning key switch 22 to a second position 22b or pressing stack control switch 16 will electrically connect key switch 22 or stack control switch 16 through control station 12, which will activate the proper control relays and motor. The electrically operated folding operable wall will then open along the operating path and stack up to the stacked side wall.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for maintaining a folding operable wall comprising:
(a) providing an electrically operated folding operable wall controlled by an electrical operation circuit and having at least one biometric verification system;
(b) recording a template of a biological trait of an authorized individual into the biometric verification system;
(c) saving the template in a database associated with the biometric verification system;
(d) capturing a new record of a biological trait of a person desiring to maintain the folding operable wall;
(e) comparing the new record against the template;
(f) authenticating the identity of the person desiring to maintain the folding operable wall if the new record is substantially similar to the saved template;
(g) preventing the electrical operation circuit from functioning if the biometric verification system fails to authenticate the identity of the person desiring to maintain the folding operable wall; and
(h) restarting the electrical operation circuit after the identity of the person desiring to maintain the folding operable wall is authenticated.

2. The method of claim 1 wherein the folding operable wall includes at least one control station and the biometric verification system is operative coupled to the at least one control station.

3. The method of claim 2 wherein the electrical operation circuit includes a preventing means having at least one control unit electrically connected between each control station of the electrical operation circuit and each biometric verification system, which will prevent the control unit from functioning if the identity of the individual desiring to maintain the folding operable wall is not authenticated

4. The method of claim 1 wherein step (e) of comparing the new record against the template employs the use of an algorithm.

5. The method of claim 1, wherein the electrical operational circuit comprises a restarting means which includes a reset control key switch in the at least one control unit, which when turned on will reactivate the electrical operation circuit and the biometric verification system.

6. The method of claim 1 wherein the electrical operation circuit comprises an extend control switch, a stack control switch, control relays and a motor.

7. The method of claim 6 wherein the step (h) of restarting comprises actuating the extend control switch or the stack control switch.

8. The method of claim 1, wherein the new record is captured from an artificial reproduction of the designated biological trait recorded in the template of the at least one biological trait of the individual trained and authorized to maintain the folding operable wall.

9. The method of claim 1, wherein the biometric verification system is selected from the group consisting of: fingerprint recognition systems, facial recognition systems, earlobe geometry recognition systems, hand geometry recognition systems, iris recognition systems, retina recognition systems, voice recognition systems, signature recognition systems, key stroke recognition systems, and combinations thereof.

10. The method of claim 1 wherein the biometric verification system comprises a fingerprint recognition system and includes a fingerprint scanner selected from the group consisting of optical sensors, ultrasonic sensors and capacitance sensors.

11. The method of claim 10 wherein step (e) of comparing the new record against the template employs the use of a pattern-based algorithm which graphically compares images of the fingerprint.

12. The method of claim 1 wherein the biometric verification system comprises a facial recognition system and the saved template comprises a digital image or a video frame from a video source.

13. The method of claim 12 wherein step (e) of comparing the new record against the template employs the use of an algorithm which analyzes the relative position, size or shape of one or more of a person's eyes, nose, cheekbone, mouth and jaw.

14. The method of claim 12 wherein the facial recognition system includes one or more 3-D sensors for capturing information about the shape of a person's face.

15. The method of claim 1 wherein the biometric verification system comprises an iris recognition system.

16. The method of claim 1 wherein the biometric verification system comprises a retina recognition system.

17. The method of claim 1 wherein the biometric verification system comprises a hand geometry recognition system.

18. The method of claim 1 wherein the biometric verification system comprises an ear lobe geometry recognition system

19. The method of claim 1 wherein the biometric verification system comprises a speaker recognition system.

20. A method for maintaining a folding operable wall comprising:
a) providing an electrically operated folding operable wall controlled by an electrical operation circuit of the type having at least one control station, an extend control switch, a stack control switch, control relays and a motor;
b) recording a template of at least one designated biological trait of an individual trained and authorized to maintain the folding operable wall into a biometric verification system coupled to the at least one control station;
c) saving the template of the at least one designated biological trait of an individual trained and authorized to maintain the folding operable wall in a database within the biometric verification system;
d) capturing from an individual desiring to maintain the folding operable wall a new record of the designated biological trait;
e) comparing the new record against the saved template using an algorithm;
f) authenticating the identity of the individual desiring to maintain the folding operable wall if the new record is substantially similar to the saved template;
g) preventing the electrical operation circuit of the folding operable wall from functioning if the biometric verification system fails to authenticate the identity of the individual desiring to maintain the folding operable wall, wherein the electrical operation circuit includes a preventing means having at least one control unit electrically connected between each control station of the electrical operation circuit and each biometric verification system, which will prevent the control unit from functioning if the identity of the individual desiring to maintain the folding operable wall is not authenticated; and
h) restarting the electrical operation circuit of the folding operable wall after the identity of the individual desiring to maintain the folding operable wall is authenticated.
